(19) United States
(12) Patent Application Publication
(10) Pub. No.: US 2015/0079846 A1
(43) Pub. Date: Mar. 19, 2015

(54) POWER SOCKET

(71) Applicant: Lausdeo Corporation, Yangmei City (TW)

(72) Inventors: Chun-Liang Yang, Taichung City (TW); Wen-Hsiang Chang, Taichung City (TW); Ming-Chieh Lin, Taichung City (TW); Jung Kuo, Taichung City (TW); Meng-Kwei Hsu, Taichung City (TW)

(73) Assignee: Lausdeo Corporation, Yangmei City (TW)

(21) Appl. No.: 14/261,895

(22) Filed: Apr. 25, 2014

(30) Foreign Application Priority Data
Sep. 16, 2013 (TW) 102217416

(51) Int. Cl. H01R 31/06; H01R 13/187

(52) U.S. Cl. CPC H01R 31/06; H01R 13/187
USPC 439/628

(57) ABSTRACT

A power socket is to be electrically connected to an internal terminal of an electronic device and to be electrically and separably connected to a plug. The plug has a tubular interior surface and an exterior surface. The power socket includes a body, a central terminal, a first conductor, and a second conductor. The body includes a surrounding wall that has an inner surface defining an accommodating space. The central terminal is disposed in the accommodating space, and is electrically connected to the internal terminal. The first conductor is disposed on the inner surface and has a first elastic portion. The second conductor is electrically connected to the central terminal, and has a second elastic portion.

### CROSS-REFERENCE TO RELATED APPLICATION

This application claims priority of Taiwanese Application No. 102217416, filed on Sep. 16, 2013, the entire disclosure of which is hereby incorporated by reference.

### BACKGROUND OF THE INVENTION

1. Field of the Invention

The invention relates to a power socket, more particularly to a power socket which is adapted to be electrically connected to an electronic device.

2. Description of the Related Art

Referring to FIG. 1, an electronic device 1, such as a notebook computer or an external storage device, can be activated upon receipt of power from a power supplier 2. The electronic device 1 includes a power socket 11 for transmitting external current into the electronic device 1. The power socket 11 includes an accommodating space 110 defined by an inner surrounding wall, a first electric terminal 111 disposed in the accommodating space 110, and a second electric terminal 112 formed on the inner surrounding wall. The power supplier 2 includes a plug 21 for transmitting current. The plug 21 has an inferior surface 211, an exterior surface 212, and an interior hole 210 defined by the interior surface 211. When the plug 21 is plugged in the power socket 11, the first electric terminal 111 is electrically connected to the interior surface 211, and the second electric terminal 112 is electrically connected to the exterior surface 212 so as to transmit current from the power supplier 2 to the electronic device 1.

Plugs made by different manufacturers or with different structural designs may have different specifications. Thus, a plurality of adaptors with different specifications may be required. Among the adaptors, one adaptor that has a specification suitable for that of the plug is selected to interconnect the plug and a power socket of an electronic device. However, the plurality of adaptors would be inconvenient to carry. Moreover, more time may be spent to find a suitable adaptor for the plug.

### SUMMARY OF THE INVENTION

Therefore, an object of the present invention is to provide a power socket that can overcome the aforesaid drawbacks of the prior art.

According to an aspect of this invention, there is provided a power socket adapted to be electrically connected to an internal terminal of an electronic device and to be electrically and separably connected to a plug. The plug has a tubular interior surface that defines an interior hole and an exterior surface that surrounds the interior surface. The power socket includes a body, a central terminal, a first conductor, and a second conductor. The body includes a surrounding wall that has an inner surface surrounding an axis and defining an accommodating space. The central terminal is disposed in the accommodating space, extends along the axis, is electrically connected to the internal terminal of the electronic device, and is configured to be insertable into the interior hole of the plug. The first conductor is disposed on the inner surface of the surrounding wall, and has a first elastic portion that projects toward the axis and that is deformable for abutting against and being electrically connected to the exterior surface of the plug. The second conductor is electrically connected to the central terminal, and has a second elastic portion that projects away from the axis and that is deformable for abutting against and being electrically connected to the interior surface of the plug.

### BRIEF DESCRIPTION OF THE DRAWINGS

Other features and advantages of the present invention will become apparent in the following detailed description of the embodiments with reference to the accompanying drawings, of which:

FIG. 1 is a fragmentary partly sectional view to illustrate electrical connection between a plug and a conventional power socket;

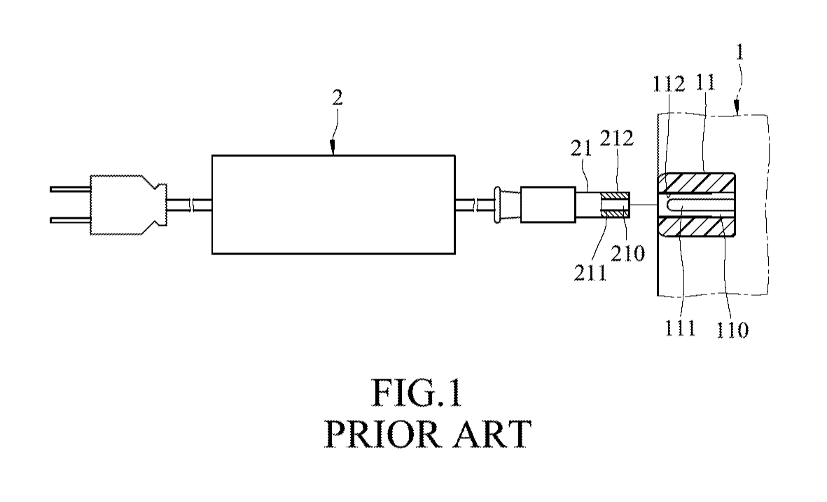

FIG. 2 is a fragmentary partly sectional view to illustrate a first embodiment of a power socket according to this indention and a power supplier;

FIG. 3 is a fragmentary partly sectional view to illustrate that the power supplier is inserted into the first embodiment of the power socket;

FIG. 4 is a fragmentary partly sectional view to illustrate the first embodiment of the power socket and a power supplier with a specification different from that of the power supplier shown in FIG. 4;

FIG. 5 is a fragmentary partly sectional view to illustrate a second embodiment of a power socket and a power supplier; and

FIG. 6 is a fragmentary partly sectional view to illustrate that the power supplier is inserted into the second embodiment of the power socket.

### DETAILED DESCRIPTION OF THE EMBODIMENTS

Before the present invention is described in greater detail with reference to the accompanying embodiments, it should be noted herein that like elements are denoted by the same reference numerals throughout the following disclosure.

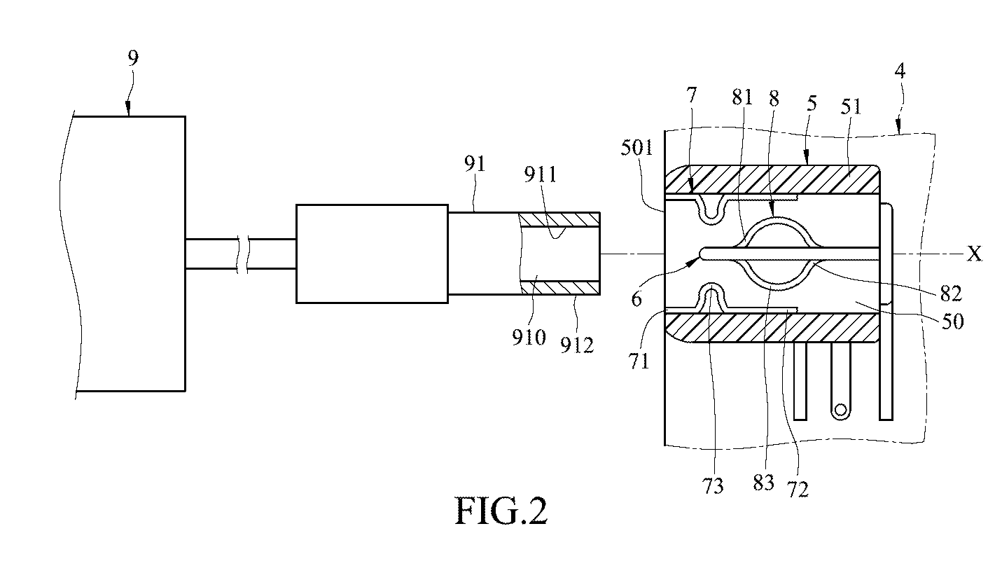

Referring to FIGS. 2, 3, and 4, a first embodiment of a power socket according to this invention is adapted to be electrically connected to an internal terminal of an electronic device 4 and to be electrically and separably connected to a plug 91 of a power supplier 9. The plug 91 has a tubular interior surface 911 that defines an interior hole 910, and an exterior surface 912 that surrounds the interior surface 911.

In this embodiment, the power socket is integrally provided in the electronic device 4. The power socket includes a body 5, a central terminal 6, a first conductor 7, and a second conductor 8.

The body 5 includes a surrounding wall 51 that has an inner surface surrounding an axis (X) and defining an accommodating space 50. The accommodating space 50 has an opening 501 for extension of the plug 91 therethrough.

The central terminal 6 is disposed in the accommodating space 50 of the body 5, extends along the axis (X), is electrically connected to the internal terminal of the electronic device 4, and is insertable into the interior hove 910 of the plug 91.

Each of the first and second conductors 7, 8 has a length in a direction of the axis (X) shorter than that of the accommodating space 50. The first conductor 7 surrounds the axis (X) and is disposed on the inner surface of the surrounding wall 51, and has a first elastic portion 73 that projects toward the axis (X) and that is deformable for abutting against and being electrically connected to the exterior surface 912 of the plug 91. The first conductor 7 further has a fixed end portion 71 secured fixedly on the inner surface of the surrounding wall 51 of the body 5, and a free end portion 72 opposite to the fixed end portion 71 and movable during deformation of the first elastic portion 73. The fixed end portion 71 of the first conductor 7 is disposed between the opening 501 and the free end portion 72 of the first conductor 7. The first elastic portion 73 is disposed between the fixed end portion 71 and the free end portion 72.

The second conductor 8 is electrically connected to the central terminal 6, and has a second elastic portion 83 that projects away from the axis (X) and that is deformable for abutting against and being electrically connected to the interior surface 911 of the plug 91. The second conductor 8 further has a fixed end portion 81 secured fixedly on the central terminal 6, and a free end portion 82 opposite to the fixed end portion 81 and movable during deformation of the second elastic portion 83. The fixed end portion 81 of the second conductor 8 is disposed between the opening 501 and the free end portion 82 of the second conductor 8. The second elastic portion 83 is disposed between the fixed end portion 81 and the free end portion 82.

The first elastic portion 73 of the first conductor 7 is spaced apart from the second elastic portion 83 of the second conductor 8. In this embodiment, the first elastic portion 73 has a minimum inner diameter smaller than a maximum diameter of the second elastic portion 83 of the second conductor 8.

When the plug 91 is inserted into the accommodating space 50 of the body 5 and the central terminal 6 is inserted into the interior hole 910 of the plug 91, the first elastic portion 73 of the first conductor 7 and the second elastic portion 83 of the second conductor 8 are respectively deformed by the exterior surface 912 and the interior surface 911, and the free end portions 72, 82 of the first and second conductors 7, 8 respectively move along the inner surface of the surrounding wall 51 and along the central terminal 6. Therefore, the first elastic portion 73 of the first conductor 7 tightly abuts against the exterior surface 912 of the plug 91, and the second elastic portion 83 of the second conductor 8 tightly abuts against the interior surface 911 of the plug 91 so that the electronic device 4 and the power supplier 9 are electrically connected with each other.

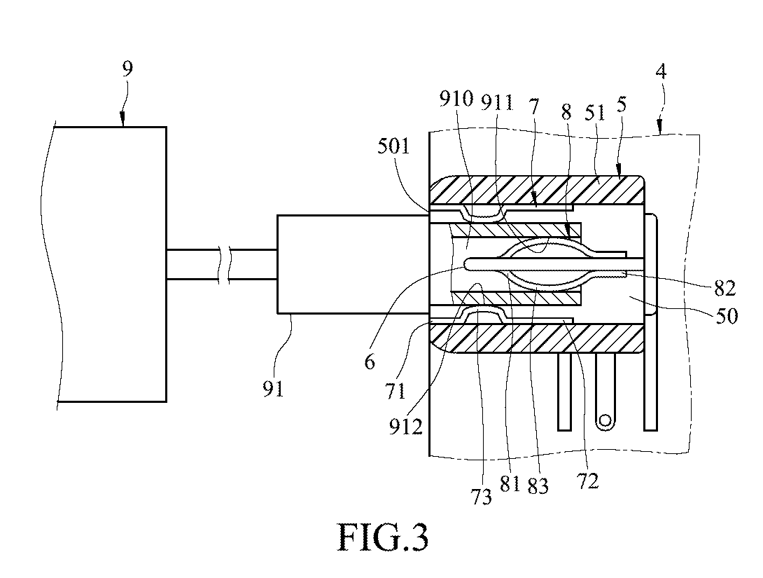

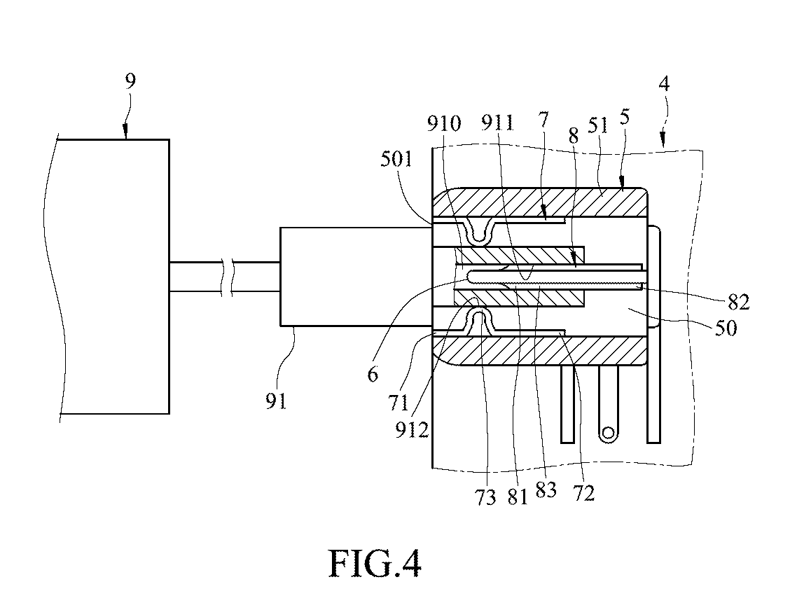

In general, the exterior surface 912 of the plug 91 has an outer diameter ranging from 4.75 mm to 6.5 mm, and the variation of the outer diameter is 1.75 mm. The interior surface 911 has an inner diameter ranging from 1.7 mm to 4.3 mm and the variation of the inner diameter is 2.6 mm. The plug 91 shown in FIG. 3 has an outer diameter of 6.5 mm and an inner diameter of 4.3 mm. The plug 91 shown in FIG. 4 has an outer diameter of 4.75 mm and an inner diameter of 1.7 mm. The first elastic portion 73 and the second elastic portion 83 have elasticity that can respectively compensate the variation of the exterior surface 912 and that of the interior hole 910. Referring to FIG. 3, since the exterior surface 912 of the plug 91 has a larger outer diameter, the first elastic portion 73 is pressed considerably, so that the free end portion 72 moves by a relatively longer distance relative to the inner surface of the surrounding wall 51. Since the interior surface 911 of the plug 91 has a larger inner diameter, the second elastic portion 83 is pressed slightly so that the free end portion 82 moves by a relatively shorter distance relative to the central terminal 6. Referring to FIG. 4, in contrast, since the exterior surface 912 of the plug 91 has a smaller outer diameter, the first elastic portion 73 is pressed slightly so that the free end portion 72 moves by a relatively shorter distance relative to the inner surface of the surrounding wall 51. Since the interior surface 911 of the plug 91 has a smaller inner diameter, the second elastic portion 83 is pressed considerably so that the free end portion 82 moves by a relatively longer distance relative to the central terminal 6.

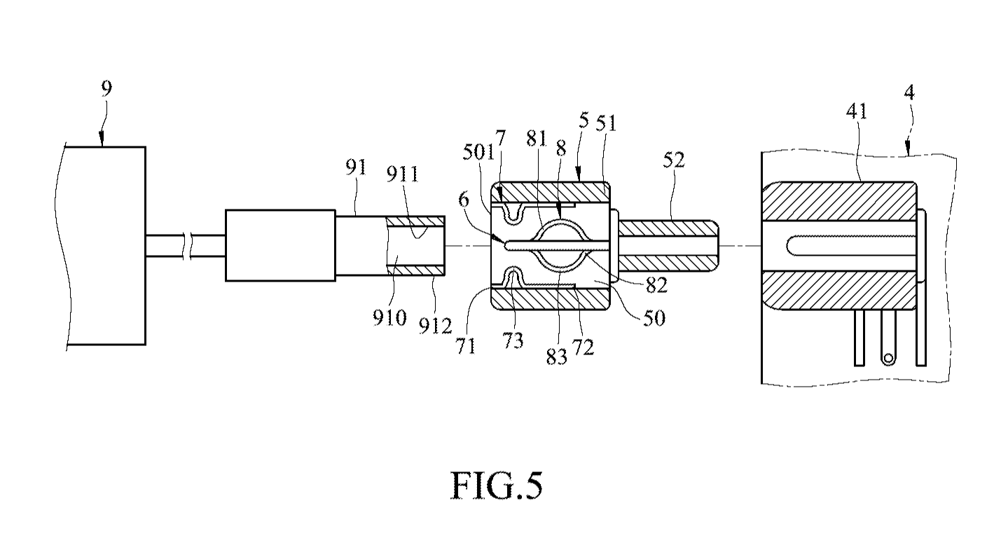

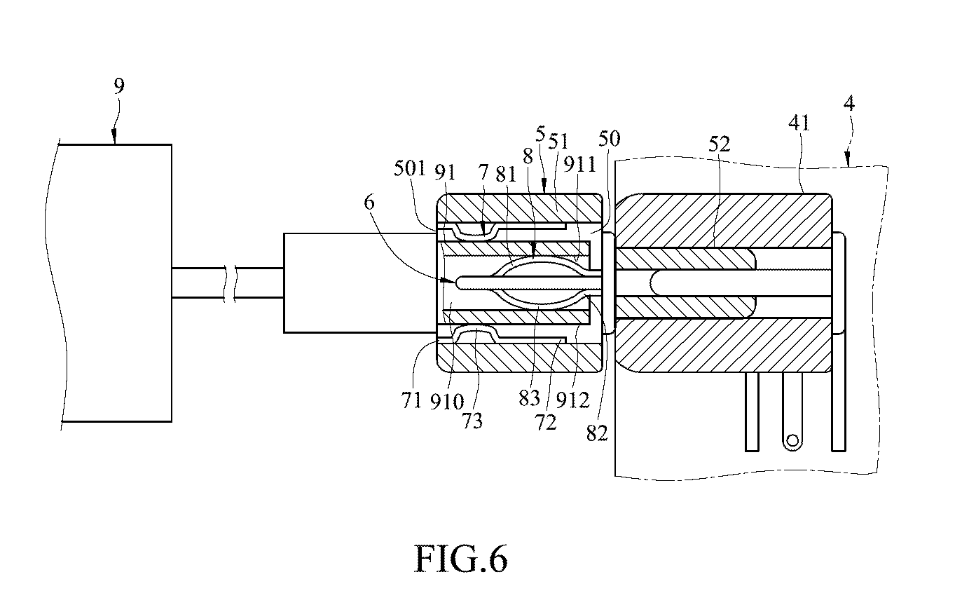

FIGS. 5 and 6 show a second embodiment of the power socket according to this invention. The electronic device 4 used to connect with the power socket of the second embodiment includes a power receptacle unit 41 that is mounted with the internal terminal. The power socket of the second embodiment is similar to that of the first embodiment, except that the body 5 of the power socket further includes a connecting portion 52 that is used to engage removably the power receptacle unit 41 for connecting electrically the central terminal 6 to the internal terminal of the electronic device 4. The connecting portion 52 is disposed at one side of the surrounding wall 51 opposite to the opening 501 and electrically connects to the first and second conductors 7, 8.

In the second embodiment, the power socket could be used to electrically connect to the electronic devices 4 and power suppliers 9 with various specifications. In use, the connecting portion 52 of the body 5 is inserted into the power socket of the electronic device 4 so as to electrically connect the power socket to the electronic device 4. Thereafter, when the plug 91 is inserted into the accommodating space 50 of the body 5, the first elastic portion 73 of the first conductor 7 and the second elastic portion 83 of the second conductor 8 respectively tightly abut against the exterior surface 912 and the interior surface 911 so as to electrically connect the power socket and the power supplier 9.

To sum up, with the compressible first elastic portion 73 and second elastic portion 83, the power socket according to this invention may be used for plugs 91 with various specifications without requiring an additional adaptor.

While the present invention has been described in connection with what considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A power socket adapted to be electrically connected to an internal terminal of an electronic device and to be electrically and separably connected to a plug, the plug having a tubular interior surface that defines an interior hole and an exterior surface that surrounds the interior surface, said power socket comprising:
a body including a surrounding wall that has an inner surface surrounding an axis and defining an accommodating space;
a central terminal disposed in said accommodating space, extending along the axis, electrically connected to the internal terminal of the electronic device, and configured to be insertable into the interior hole of the plug;
a first conductor disposed on said inner surface of said surrounding wall, and having a first elastic portion that projects toward the acts and that is deformable for abutting against and being electrically connected to the exterior surface of the plug; and
a second conductor electrically connected to said central terminal, and having a second elastic portion that projects away from the axis and that is deformable for abutting against and being electrically connected to the interior surface of the plug.

2. The power socket according to claim 1, the electronic device including a power receptacle unit that is mounted with the internal terminal, wherein said body of said power socket further includes a connecting portion adapted to engage removably the power receptacle unit for connecting electrically said central terminal to the internal terminal of said electronic device.

3. The power socket according to claim 1, wherein said first elastic portion of said first conductor is spaced apart from said second elastic portion of said second conductor, and has a minimum inner diameter smaller than a maximum diameter of said second elastic portion of said second conductor.

4. The power socket according to claim 1, wherein:
said first conductor further has a fixed end portion secured fixedly on said inner surface of said surrounding wall of said body, and a free end portion opposite to said fixed end portion and movable during deformation of said first elastic portion; and
said second conductor further has a fixed end portion secured fixedly on said central terminal, and a free end portion opposite to said fixed end portion and movable during deformation of said second elastic portion.

5. The power socket according to claim 4, wherein said accommodating space has an opening for extension of the plug therethrough, said fixed end portion of said first conductor being disposed between said opening and said free end portion of said first conductor, said fixed end portion of said second conductor being disposed between said opening and said free end portion of said second conductor.

6. The power socket according to claim 1, wherein each of said first and second conductors has a length in a direction of the axis shorter than that of said accommodating space.
